(19) United States
(12) Patent Application Publication
(10) Pub. No.: US 2020/0241625 A1
(43) Pub. Date: Jul. 30, 2020

(54) TRANSITIONING UNIVERSAL FLASH STORAGE (UFS) GEARS DURING A CLOCK GATE/HIBERNATION DELAY

(71) Applicant: QUALCOMM Incorporated, San Diego, CA (US)

(72) Inventors: Madhu Yashwanth BOENAPALLI, Hyderabad (IN); Venu Madhav MOKKAPATI, Hyderabad (IN); Yogananda Rao CHILLARIGA, Hyderabad (IN)

(21) Appl. No.: 16/256,817

(22) Filed: Jan. 24, 2019

(51) Int. Cl. G06F 1/3234; G06F 13/16; G06F 13/42

(52) U.S. Cl. CPC G06F 1/3268; G06F 2213/0036; G06F 13/4282; G06F 13/1668

(57) ABSTRACT

An apparatus configured to transition universal flash storage (UFS) gears. The apparatus includes a serial interconnect coupled to a UFS device. The serial interconnect is configured to support gears. The apparatus also includes a host controller. The host controller is configured to switch between a requested gear and a selected gear of the serial interconnect prior to entering a hibernation mode.

### BACKGROUND

### Field

The present disclosure generally relates to apparatuses incorporating integrated circuits (ICs). More specifically, aspects of the present disclosure relate to an apparatus and method of transitioning universal flash storage (UFS) gears during a clock gate/hibernation delay.

### Background

Electronic devices, such as computers, smart phones, mobile devices, Internet of Things (IoT), and other like mobile platform devices are continually driving the demand for faster data. Conventional volatile memory used in mobile platform devices may be unable to handle and facilitate the voluminous data consumed by such mobile platform devices. One option for meeting this ever expanding volume of data is using high-speed non-volatile (NV) memory devices. For example, flash memory is one possible type of NV memory device that may be capable of meeting this ever expanding volume of data consumed by mobile platform devices.

A flash memory storage device is a type of non-volatile memory implemented using solid-state drive (SSD) technology. For example, SSD-based flash memory is an electronic non-volatile computer storage device capable of maintaining, erasing, and/or reprogramming data. Flash memory can be fabricated with several different types of integrated circuit (IC) technologies, such as a negative logical OR (NOR) gate or a negative logical AND (NAND) gate using, for example, floating-gate transistors. This flash memory can be configured to support block-based, page-based, word-based, and/or byte-based memory access, depending on the type of supported applications.

The internal memories of the noted mobile platform devices may be implemented using universal flash storage (UFS). Universal flash storage or UFS is a flash storage specification for consumer electronic devices, such as mobile phones, digital cameras, and other like consumer electronic devices specifying high performance and low power consumption. Unfortunately, current operation of universal flash storage may waste power when operating using different UFS gears, which specify different speeds for serial interface lines to UFS devices. A technique for transitioning UFS gears during a clock gate/hibernation delay is desired.

### SUMMARY

An apparatus configured to transition universal flash storage (UFS) gears. The apparatus includes a serial interconnect coupled to a UFS device. The serial interconnect is configured to support gears. The apparatus also includes a host controller. The host controller is configured to switch between a requested gear and a selected gear of the serial interconnect prior to entering a hibernation mode.

A method of transitioning gear speeds for communicating over a serial interconnect is described. The method includes receiving a request to enter a hibernation mode. The request is received after processing pending input/output (I/O) requests according to a requested gear of the serial interconnect. The method also includes switching between the requested gear and a selected gear of the serial interconnect prior to entering the hibernation mode.

A non-transitory computer-readable medium having program code recorded thereon for transitioning gear speeds for communicating over a serial interconnect is described. The program code is executed by a processor and includes program code to receive a request to enter a hibernation mode. The request is received after processing pending input/output (I/O) requests according to a requested gear of the serial interconnect. The program code also includes program code to switch between the requested gear and a selected gear of the serial interconnect prior to entering the hibernation mode.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily used as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a system-on-a-chip (SOC), including a connectivity module, in accordance with certain aspects of the present disclosure.

FIG. 2 is an example implementation illustrating a host controller communicably coupled to universal flash storage (UFS) devices, in accordance with aspects of the present disclosure.

FIG. 3 is an example implementation illustrating a host controller having separate universal flash storage (UFS) hosts configured to transition UFS gears prior to a clock-gating/hibernate mode, in accordance with aspects of the present disclosure.

FIG. 4 is a gear downshift graph illustrating gear-shifting intervals for transitioning universal flash storage (UFS) gears prior to clock gate/hibernation mode, according to aspects of the present disclosure.

FIG. 5 is a variable gear downshift graph illustrating variable gear-shifting intervals for transitioning universal flash storage (UFS) gears prior to clock gate/hibernation mode, according to aspects of the present disclosure.

FIG. 6 is a flow diagram illustrating a method of transitioning gear speeds for communicating over a high-speed serial interconnect, according to aspects of the present disclosure.

FIG. 7 is a block diagram showing a wireless communications system in which a configuration of the disclosure may be advantageously employed.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. The apparatus may, for example, be one of a computing system (e.g., servers, datacenters, desktop computers), mobile computing device (e.g., laptops, cell phones, vehicles, etc.), Internet of Things device, and virtual reality or augmented reality system. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

As described herein, the use of the term “and/or” is intended to represent an “inclusive OR”, and the use of the term “or” is intended to represent an “exclusive OR”. The word “exemplary” is used herein to mean “serving as an example, instance, or illustration.” Any aspect described herein as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure, rather than limiting the scope of the disclosure being defined by the appended claims and equivalents thereof.

Internal memories of mobile platform devices may be implemented with universal flash storage (UFS). Universal flash storage or UFS is a flash storage specification for consumer electronic devices, such as mobile phones, digital cameras, and other like consumer electronic devices specifying high performance and low power consumption. Flash memory is a type of non-volatile memory implemented using solid-state drive (SSD) technology. For example, SSD-based flash memory is an electronic non-volatile computer storage device capable of maintaining, erasing, and/or reprogramming data.

A current universal flash storage specification (UFS 3.0) describes a high-speed serial interface targeting high serial communications (e.g., 2.9 gigabits (Gbit) per second (Gbit/s) per lane) with scalability up to a predetermined speed (e.g., 5.8 Gbit/s per lane). This current specification defines four high-speed (HS) gears (HS-G1, HS-G2, HS-G3, HS-G4). Each gear supports different speeds of transmissions per second (e.g. HS-G1<<HS-G4). In operation, a UFS controller services input/output (I/O) requests in a UFS request queue, in which each I/O request specifies a requested gear. For example, if there is an I/O request in queue, UFS-controller scales up or down between the high-speed gears based on the requested gear and then services the I/O request.

Unfortunately, once the UFS request queue is empty, the UFS controller remains in the last requested high-speed gear for a predetermined period of time and then scales down to lowest possible gear (e.g., gear zero (G0)) and hibernates. That is, after servicing all the I/O requests in the UFS request queue (e.g., queue=0), the host controller stays in the same gear used for the last I/O request for the predetermined period of time. For example, in the current specification, the predetermined period of time is pre-configured and depends on a clock gate delay (clkgate_delay) or a hibernate on idle delay (hibern8_on_idle_delay). The clock gate/hibernation delay may be approximately two hundred (200) milliseconds (ms). This current UFS specification fails to recognize available power optimization available by intelligently shifting gears prior to entering a hibernation mode. That is, the current UFS specification wastes power by staying in the current gear for so much time (e.g., 200 ms).

According to aspects of the present disclosure, a gear scale-down process is described to reduce power consumption incurred during clock-gating/hibernation mode. This gear scale-down process decides which high-speed gear to enter and the duration of time the host controller should be staying back in a gear before hibernating to improve power usage. In one configuration, counters are assigned for each high-speed gear, in which the respective counters denote the number of I/O requests served in a corresponding gear since boot up. These gear counters provide a history of which gear was most requested for enabling intelligent gear scale-down prior to entering hibernation mode.

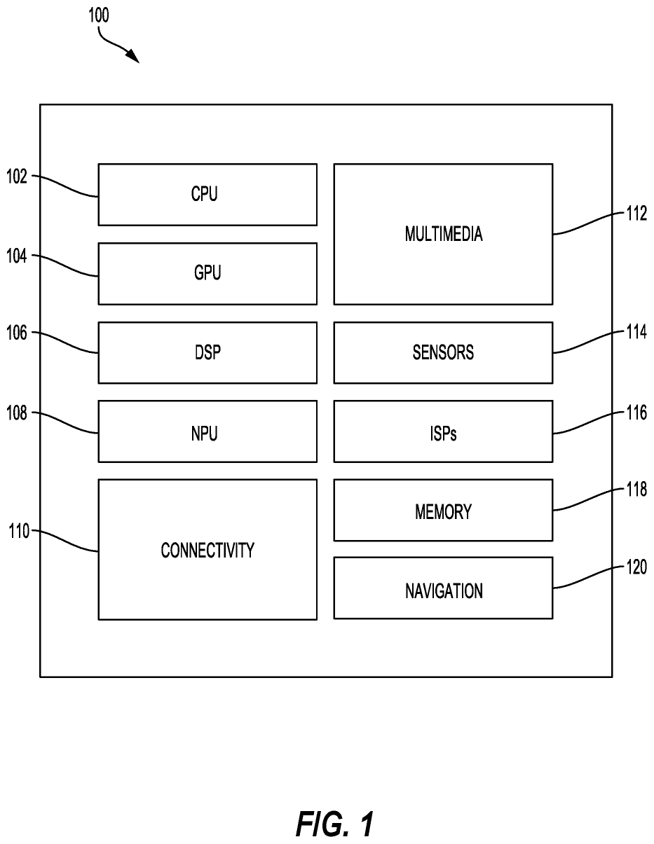

FIG. 1 illustrates an example implementation of a host system-on-a-chip (SOC) 100, which includes a connectivity block 110 (e.g., a host controller) configured to transition universal flash storage (UFS) gears during a clock gate/hibernation delay, in accordance with aspects of the present disclosure. The host SOC 100 includes processing blocks tailored to specific functions, such as the connectivity block 110, which may include fifth generation (5G) connectivity, fourth generation long term evolution (4G LTE) connectivity, Wi-Fi connectivity, USB connectivity, Bluetooth connectivity, secure digital (SD) connectivity, and the like.

In this configuration, the host SOC 100 includes various processing units that support multi-threaded operation. For the configuration shown in FIG. 1, the host SOC 100 includes a multi-core central processing unit (CPU) 102, a graphics processor unit (GPU) 104, a digital signal processor (DSP) 106, and a neural processor unit (NPU) 108. The host SOC 100 may also include a sensor processor 114, image signal processors (ISPs) 116, a navigation module 120, which may include a global positioning system, and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) machine, an advance RISC machine (ARM), a microprocessor, or some other type of processor. The NPU 108 may be based on an ARM instruction set.

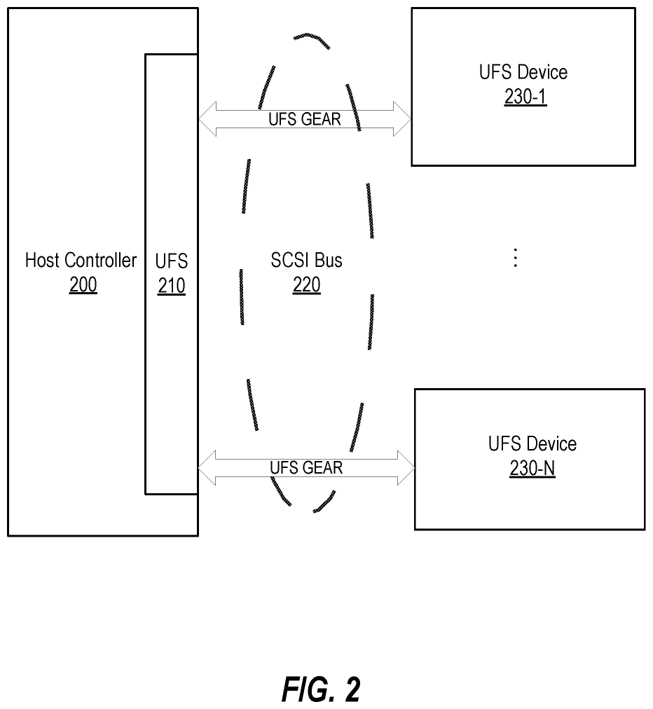

FIG. 2 is an example implementation illustrating a host controller configured to transition universal flash storage (UFS) gears prior to entering a clock-gating/hibernate mode, in accordance with aspects of the present disclosure. In this configuration, a host controller 200 may be the host SOC 100, or a block of the host SOC 100 (e.g., connectivity block 110 or other like block of the host SOC 100) including a UFS interface 210. In this example, the host controller 200 includes the UFS interface 210, configured to communicate with UFS devices 230 (230-1, . . . , 230-N) over, for example, a small computer system interface (SCSI) bus 220.

As previously noted, the host controller 200 services input/output (I/O) requests in a UFS request queue (not shown), in which each I/O request specifies a requested gear. For example, if there is an I/O request in queue, the host controller 200 scales up or down between the high-speed gears based on the requested gear and then services the I/O request. This current UFS specification fails to recognize available power optimization available by intelligently shifting gears prior to entering a hibernation mode. That is, the current UFS specification wastes power by staying back in the current gear for too long. According to aspects of the present disclosure, a gear scale-down process is described to reduce power consumption incurred during clock-gating/hibernation mode based on current power and performance constraints.

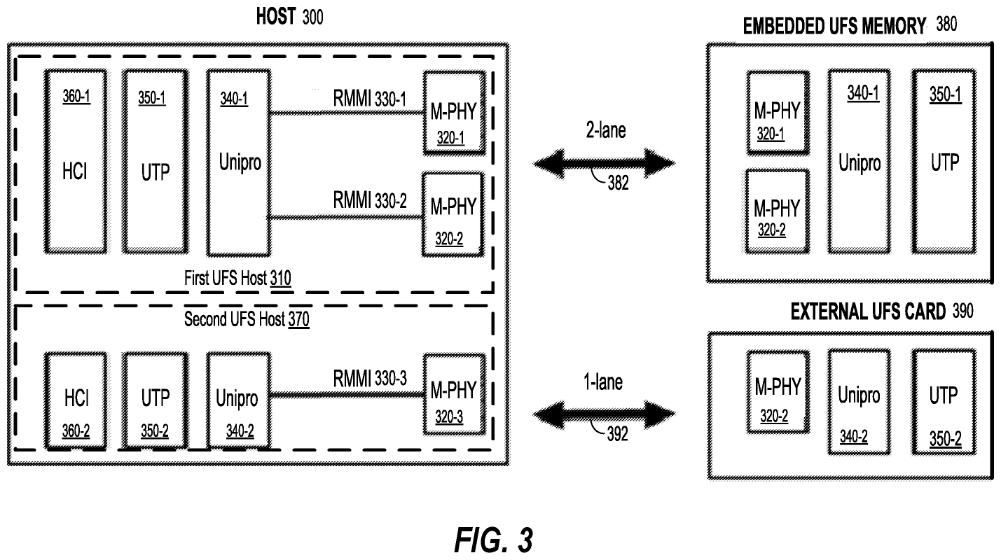

FIG. 3 is an example implementation illustrating a host controller having dual universal flash storage (UFS) hosts configured to transition UFS gears prior to entering a clock-gating/hibernate mode, in accordance with aspects of the present disclosure. In this configuration, a host controller 300 may be the host SOC 100, or a block of the host SOC 100 (e.g., connectivity block 110 or other like block of the host SOC 100) including separate UFS hosts. This configuration includes a first UFS host 310 configured to communicate with an embedded UFS memory 380, and a second UFS host 370 configured to communicate with an external UFS card 390 for various I/O operations. The embedded UFS memory 380 and the external UFS card 390 may be referred to as a universal flash storage (UFS) device. Alternatively, the embedded UFS memory 380 and the external UFS card 390 may be referred to as a universal flash storage (UFS) memory system.

In this configuration, the first UFS host 310 and the second UFS host 370 include a mobile physical layer (M-PHY) 320 (320-1, 320-2, 320-3) for supporting a two-lane link 382 or a one-lane link 392 of traffic. In this example, the host controller 300 is designed to support both an embedded UFS memory 380 over the two-lane link 382 and an external UFS card 390 over the one-lane link 392. The first UFS host 310 and the second UFS host 370 also include a reference M-PHY module interface (RMMI) router 330 (330-1, 330-2, 330-3) coupled between a unified protocol link layer (Unipro) 340 (340-1, 340-2) and the M-PHY 320.

The first UFS host 310 and the second UFS host 370 also include a host controller interface (HCI) 360 (360-1, 360-2) and a UFS transport protocol (UTP) 350 (350-1, 350-2) as defined in the Joint Electron Device Engineering Council (JEDEC) standard. The Unipro 340 and the physical interface referred to as M-PHY 320 are defined by the Mobile Industry Processor Interface (MIPI) alliance. Within the first UFS host 310 and the second UFS host 370, the Unipro 340 and the M-PHY 320 are designed to communicate through an interface or bus referred to as the RMMI 330, which is also defined in the MIPI standard.

In this example, the UFS memory systems (e.g., 380 and 390) as well as the interfaces of the embedded UFS memory 380 and the external UFS card 390 to the first UFS host 310 and the second UFS host 370 also include multiple layers to support the standards. The embedded UFS memory 380 and the external UFS card 390 that communicate with the first UFS host 310 and the second UFS host 370 also include counterpart layers (e.g., the UTP 350, the Unipro 340, and the M-PHY 320). Each of the M-PHY 320 supports a specific number of bits or pins, referred to in units of lanes.

In this configuration, the embedded UFS memory 380 is a two-lane device that communicates over the two-lane link 382. The external UFS card 390 may be a UFS card that is typically a removable device and supports a single lane of memory traffic over the one-lane link 392. The embedded UFS memory 380 is a two-lane device that communicates over the two-lane link 382 and operates according to high-speed (HS) UFS gears (e.g., HS-G1, HS-G2, HS-G3, and HS-G4). The external UFS card 390 supports a single lane of memory traffic over the one-lane link 392 that operates according to high-speed (HS) UFS gears (e.g., HS-G1, HS-G2, and HS-G3), as per the specifications from the JEDEC.

Each gear supports different speeds of transmissions per second (e.g. HS-G1<<HS-G4). In operation, the first UFS host 310 and the second UFS host 370 services input/output (I/O) requests in a UFS request queue (not shown), in which each I/O request specifies a requested gear. For example, if there is an I/O request in queue, the first UFS host 310 scales up or down between the high-speed gears based on the requested gear and then services the I/O request.

Unfortunately, once the UFS request queue is empty, the first UFS host 310 (and/or the second UFS host 370) remains in the last requested high-speed gear for a predetermined period of time and then scales down to lowest possible gear (e.g., gear zero (G0)) and hibernates. For example, in the current specification, the predetermined period of time is pre-configured and depends on a clock gate delay (clkgate_delay) or a hibernate on idle delay (hibern8_on_idle_delay). The clock gate/hibernation delay may be approximately two hundred (200) milliseconds (ms). This current UFS specification fails to recognize available power optimization available by intelligently shifting gears prior to entering a hibernation mode. According to the current UFS specification, the first UFS host 310 and the second UFS host 370 waste power by staying in the current (e.g., requested) gear for too long.

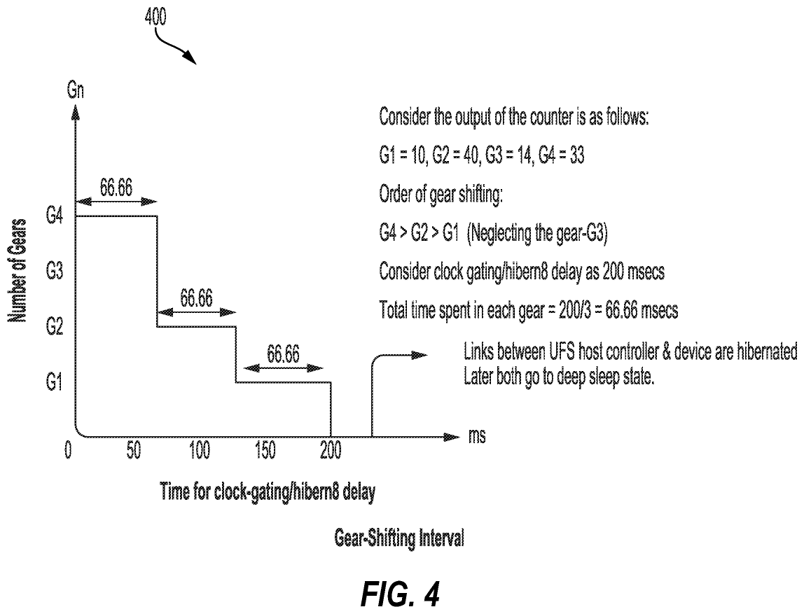

FIG. 4 is a gear downshift graph 400 illustrating gear-shifting intervals for transitioning universal flash storage (UFS) gears prior to a clock gate/hibernation mode, according to aspects of the present disclosure. According to aspects of the present disclosure, a gear scale-down process is described to reduce power consumption incurred during a clock-gating/hibernation mode. This gear scale-down process decides which high-speed gear to use and a duration the UFS host (e.g., 310 and 370) stays in the high-speed gear before hibernating to improve power usage. In one configuration, counters are assigned for each high-speed gear, in which the respective counters denote the number of I/O requests served in a corresponding high-speed gear since boot up. These gear counters provide a history of which UFS gear was most requested for enabling intelligent gear scale-down prior to entering a hibernation mode.

As shown in FIGS. 3 and 4, whenever an I/O request enters a request queue (not shown), the I/O request specifies a high-speed gear for servicing the I/O request. For example, once the I/O request is serviced, the first UFS host 310 and/or the second UFS host 370 stays in the requested high-speed gear for a pre-configured time before returning to a zero gear and entering a hibernation mode. In this aspect of the present disclosure, a new counter for each gear is proposed, which indicates a number of I/O requests served by the UFS host in that high-speed gear.

The gear downshift graph 400 of FIG. 4 illustrates gear shifting intervals for four gears (e.g., G1, G2, G3, G4), which consume power in the same increasing order of speed. In this example, I/O counts (e.g., 10, 40, 14, 33) for the four gears (e.g., G1, G2, G3, G4), respectively, are also provided. In addition, a zero-gear (GO) indicates a shutdown/hibernate mode. The most recent I/O request is serviced by the first UFS host 310 and/or the second UFS host 370 in the high-speed gear G4 and the I/O request queue is empty, triggering a clock gate/hibernation mode. Prior to entering the clock gate/hibernation mode, the UFS host (e.g., 310/370) identifies the high-speed gear used to service the maximum number of I/O requests, with less power consumption than high-speed gear G3.

In this example, the high-speed gear G2 has the highest I/O request count (=40). Moving to high-speed gear G2, therefore, provides the highest probability of servicing a next I/O request in the same high-speed gear. Because the UFS host (e.g., 310/370) focuses on the high-speed gears with lesser speed than the current gear, power is saved. In addition, by choosing the high-speed gear with a highest counter value, there is an increased probability of servicing the next I/O request in the same gear.

The gear downshift graph 400 of FIG. 4 is a time verses gear graph illustrating a fixed gear-shifting interval, in which high-speed gear G3 is skipped. In addition to selecting the high-speed gear to shift into when the I/O request queue is empty, another aspect of the present disclosure selects the duration of time the UFS host (e.g., 310/370) spends in each high-speed gear prior to gear zero G0 and entering the hibernation mode. In this example, the pre-configured time prior to entering the hibernate mode (e.g., clkgate_delay or hibern8_on_idle_delay of 200 ms) is divided by the number of high-speed gears to downshift into prior to the hibernation mode according to Equation (1), as follows:

Time interval for shifting gears (T1)=(X/Y), (1)

where Y is the number of gears and X is delay time.

In the current example, the UFS host (e.g., 310/370) downshifts from the high-speed gear G4 to the high-speed gear G2, and then to the high-speed gear G1 before entering hibernate mode in gear GO. Based on the three high-speed gears (e.g., G4, G2, and G1), the time spent in each high-speed gear before downshifting is 66.66 ms (=200 ms/3). The gear downshift graph 400 depicts downshifting of the high-speed gears happening on a time division basis. The UFS host (e.g., 310/370) serves 66.66 ms of time in each of high-speed gears G4, G2, and G1. After completing the pre-configured time (e.g., the clkgate_delay or the hibern8_on_idle_delay), the links (e.g., the two-lane link 382 and/or the one-lane link 392) between the UFS host controller (e.g., 310/370) and the UFS memory systems (e.g., 380 and 390) are shut down. Once the links are shut down, both the UFS host controller (e.g., 310/370) and the UFS memory systems (e.g., 380 and 390) are hibernated.

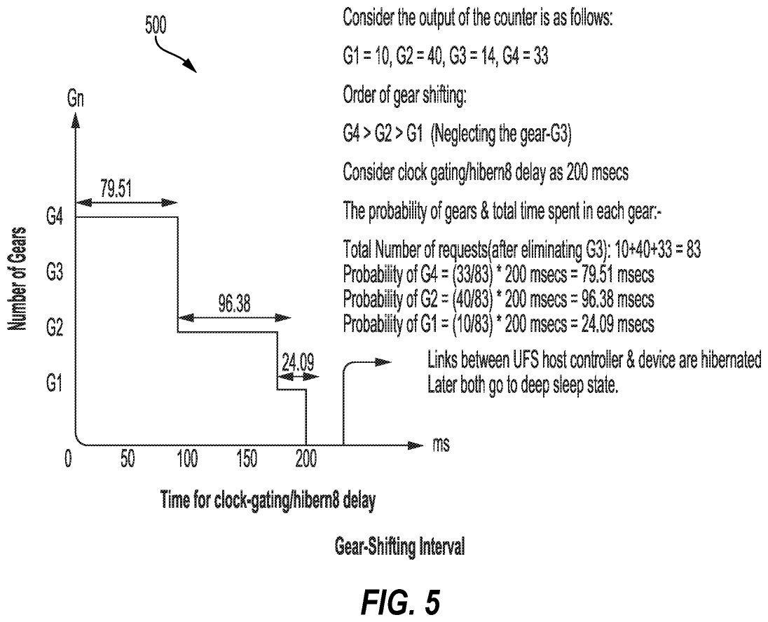

FIG. 5 is a variable interval downshift gear graph 500 illustrating variable gear-shifting intervals for transitioning universal flash storage (UFS) gears prior to clock gate/hibernation mode, according to aspects of the present disclosure. This configuration adds additional intelligence to the fixed gear shifting intervals (e.g., 66 ms) shown in FIG. 4. In this example, the time intervals before downshifting to a different high-speed gear are defined based on the following parameters: (1) the numbers of supported gears (Y); (2) what the time for clock-gating/hibernating delay is (X) ms; (3) the probability of getting an I/O request in the current gear=(counter of gear)/(Total count); and (4) time spent by each high-speed gear=the probability of getting an I/O request multiplied (*) by the clock gating/hibernate delay.

As shown in FIG. 5, the variable interval downshift gear graph 500 depicts gear shifting when the I/O request queue is empty. In this aspect of the present disclosure, an amount of time spent in each high-speed gear varies by the ratio of I/O requests. For example, the following amounts of time are spent in high-speed gears G4, G2, and G1: (1) in high-speed gear G4, (33/83)*200 ms (=79.51 ms); (2) in high-speed gear G2, (40/83)*200 ms (=96.38 ms); and (3) in high-speed gear G1, (10/83)*200 ms (=24.09 ms). This solution increases the probability of serving an I/O request with the requested high-speed gear, while improving power usage.

As shown in FIGS. 4 and 5, high-speed gear G3 is neglected. In these examples, the various high-speed gears are ranked as follows based on the number of I/O requests indicated by a respective gear counter: the number of I/O requests for high-speed gear G4 is greater than the number of I/O requests for high-speed gear G2, which is greater than the number of I/O requests for high-speed gear G3, which is greater than the number of I/O requests for high-speed gear G1. If the high-speed gear ranking is strictly followed, high-speed gear G3 should be shifted into after downshifting to high-speed gear G2. Unfortunately, switching from a lower power domain of high-speed gear G2 to the higher power domain of high-speed gear G3 consumes more power. Hence, high-speed gear G3 is neglected in the configuration of FIGS. 4 and 5. In cases where the I/O request count for two high-speed gears is the same, the high-speed gear with the lower power domain is selected.

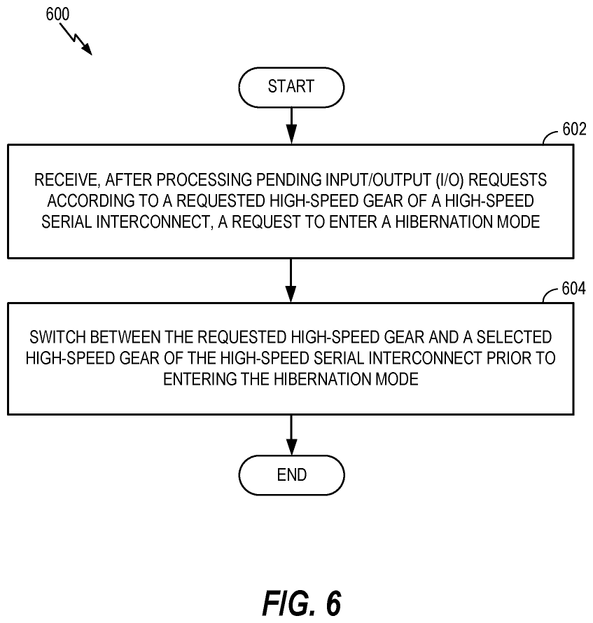

FIG. 6 is a flow diagram illustrating a method of transitioning gear speeds for communicating over a high-speed serial interconnect, according to aspects of the present disclosure. A method 600 begins at block 602, in which a request to enter a hibernation mode is received after processing pending input/output (I/O) requests according to a requested high-speed gear of the high-speed serial interconnect. For example, as shown in FIGS. 3 and 4, a UFS host (e.g., 310/370) receives a request to enter a hibernation mode after servicing a last I/O request in high-speed gear G4.

Referring again to FIG. 6, at block 604, a switch between the requested high-speed gear and a selected high-speed gear of the high-speed serial interconnect is performed prior to entering the hibernation mode. For example, in FIGS. 3 and 4, the UFS host (e.g., 310/370) downshifts from the high-speed gear G4 to the high-speed gear G2 after a fixed period of time (e.g., 66 ms). Alternatively, as shown in FIG. 5, the UFS host (e.g., 310/370) downshifts from the high-speed gear G4 to the high-speed gear G2 after a first variable period of time (e.g., 79.51 ms). As further shown in FIG. 5, the UFS host (e.g., 310/370) downshifts from the high-speed gear G2 to another selected high-speed gear after a second variable period of time (e.g., 96.38 ms).

In this aspect of the present disclosure, a host controller (e.g., the first UFS host 310 and/or the second UFS host 370) intelligently downshifts high-speed gears prior to entering a hibernation mode. This UFS gear downshifting process may save power by staying in the high-speed gear having the highest probability of being requested in the next I/O request. In addition, a turnaround time for shifting the high-speed gear and serving an I/O request is eliminated by this process.

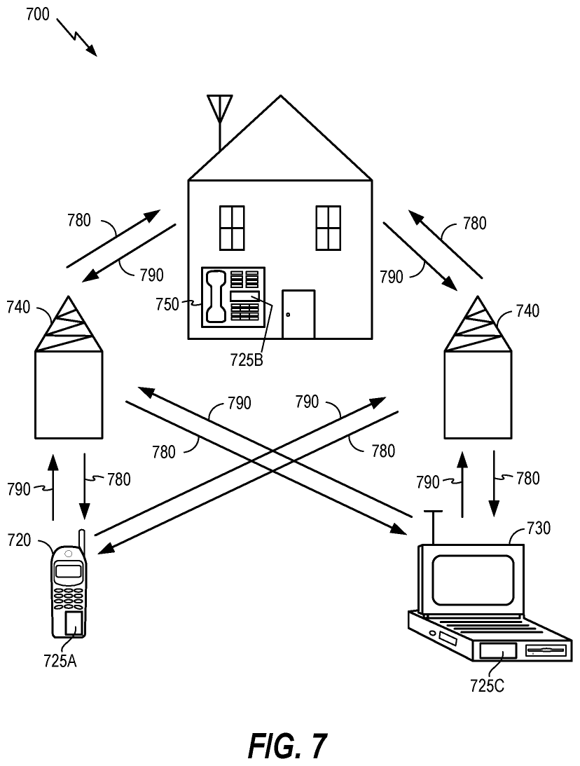

FIG. 7 is a block diagram showing an exemplary wireless communications system 700 in which a configuration of the disclosure may be advantageously employed. For purposes of illustration, FIG. 7 shows three remote units 720, 730, and 750 and two base stations 740. It will be recognized that wireless communications systems may have many more remote units and base stations. Remote units 720, 730, and 750 include IC devices 725A, 725B, and 725C, which include the disclosed UFS interface. It will be recognized that any device containing an IC may also include the disclosed UFS interface, including the base stations, switching devices, and network equipment. FIG. 7 shows forward link signals 780 from the base station 740 to the remote units 720, 730, and 750, and reverse link signals 790 from the remote units 720, 730, and 750 to base stations 740.

In FIG. 7, a remote unit 720 is shown as a mobile telephone, a remote unit 730 is shown as a portable computer, and a remote unit 750 is shown as a fixed location remote unit in a wireless local loop system. For example, the remote units may be a mobile phone, a hand-held personal communications systems (PCS) unit, a portable data unit such as a personal data assistant, a GPS enabled device, a navigation device, a set top box, a music player, a video player, an entertainment unit, a fixed location data unit such as meter reading equipment, or any other device that stores or retrieves data or computer instructions, or any combination thereof. For example, a remote unit including the UFS interface may be integrated within a vehicle control system, a server computing system or other like system specifying critical data integrity. Although FIG. 7 illustrates IC devices 725A, 725B, and 725C, which include the disclosed UFS interface, the disclosure is not limited to these exemplary illustrated units. Aspects of the present disclosure may be suitably employed in any device, which includes the UFS interface.

For a firmware and/or software implementation, the methodologies may be implemented with modules (e.g., procedures, functions, and so on) that perform the described functions. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a non-transitory computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer. Disk and disc, as used herein, include compact disc (CD), laser disc, optical disc, digital versatile disc (DVD) and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof If implemented in software, the functions may be stored on or transmitted over as one or more instructions or code on a computer-readable medium. Computer-readable media includes both computer storage media and communications media including any medium that facilitates transfer of a computer program from one place to another. A storage media may be any available media that can be accessed by a general-purpose or special-purpose computer. By way of example, and not limitation, such computer-readable media can include RAM, ROM, EEPROM, CD-ROM or other optical disk storage, magnetic disk storage or other magnetic storage devices, or any other medium that can be used to carry or store specified program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD) and Blu-ray disc, where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “a step for.”

What is claimed is:

1. An apparatus configured to transition universal flash storage (UFS) gears, comprising:
a serial interconnect coupled to a UFS device and configured to support a plurality of gears; and
a host controller configured to switch between a requested gear and a selected gear of the serial interconnect prior to entering a hibernation mode.

2. The apparatus of claim 1, comprising one of one of a computing system, mobile computing device, Internet of Things device, or virtual reality or augmented reality system, incorporating the host controller, the serial interconnect, and the UFS device.

3. The apparatus of claim 1, in which the UFS device comprises a universal flash storage (UFS) memory system coupled to the serial interconnect.

4. The apparatus of claim 3, in which the UFS memory system comprises an embedded UFS memory, and the serial interconnect comprises a two-lane link.

5. The apparatus of claim 3, in which the UFS memory system comprises an external UFS card, and the serial interconnect comprises a one-lane link.

6. The apparatus of claim 1, in which the host controller comprises dual universal flash storage (UFS) hosts, including a first UFS host and a second UFS host.

7. A method of transitioning gear speeds for communicating over a serial interconnect, the method comprising:
receiving, after processing pending input/output (I/O) requests according to a requested gear of the serial interconnect, a request to enter a hibernation mode; and
switching between the requested gear and a selected gear of the serial interconnect prior to entering the hibernation mode.

8. The method of claim 7, further comprising remaining in the requested gear for a fixed period of time before downshifting to the selected gear of the serial interconnect.

9. The method of claim 8, further comprising remaining in the selected gear for the fixed period of time before downshifting to another selected gear of the serial interconnect.

10. The method of claim 7, further comprising remaining in the requested gear for a first variable period of time before downshifting to the selected gear of the serial interconnect.

11. The method of claim 10, further comprising remaining in the selected gear for a second variable period of time before downshifting to another selected gear of the serial interconnect.

12. The method of claim 11, in which the second variable period of time is greater than the first variable period of time.

13. The method of claim 7, in which switching further comprises downshifting from the requested gear to the selected gear.

14. A non-transitory computer-readable medium having program code recorded thereon for transitioning gear speeds for communicating over a serial interconnect, the program code executed by a processor and comprising:
program code to receive, after processing pending input/output (I/O) requests according to a requested gear of the serial interconnect, a request to enter a hibernation mode; and
program code to switch between the requested gear and a selected gear of the serial interconnect prior to entering the hibernation mode.

15. The non-transitory computer-readable medium of claim 14, further comprising program code to remain in the requested gear for a fixed period of time before downshifting to the selected gear of the serial interconnect.

16. The non-transitory computer-readable medium of claim 15, further comprising program code to remain in the selected gear for the fixed period of time before downshifting to another selected gear of the serial interconnect.

17. The non-transitory computer-readable medium of claim 14, further comprising program code to remain in the requested gear for a first variable period of time before downshifting to the selected gear of the serial interconnect.

18. The non-transitory computer-readable medium of claim 17, further comprising program code to remain in the selected gear for a second variable period of time before downshifting to another selected gear of the serial interconnect.

19. The non-transitory computer-readable medium of claim 18, in which the second variable period of time is greater than the first variable period of time.

20. The non-transitory computer-readable medium of claim 14, in which the program code to switch further comprises program code to downshift from the requested gear to the selected gear.
